(19) United States
(12) Patent Application Publication
(10) Pub. No.: US 2014/0147703 A1
(43) Pub. Date: May 29, 2014

(54) BATTERY SAFETY CIRCUIT AND TAB PLACEMENT AND ORIENTATION

(71) Applicant: APPLE INC., Cupertino, CA (US)

(72) Inventors: Christopher M. Werner, San Jose, CA (US); Teodor Dabov, San Francisco, CA (US); Emery A. Sanford, San Francisco, CA (US)

(73) Assignee: Apple Inc., Cupertino, CA (US)

(21) Appl. No.: 13/687,698

(22) Filed: Nov. 28, 2012

(51) Int. Cl. H01M 2/34

(52) U.S. Cl. CPC H01M 2/34
USPC 429/7; 29/623.1

(57) ABSTRACT

In a first embodiment, a battery pouch has a long edge seal and a short edge seal. An electrical connection tab is positioned on the short edge seal and at least a portion of a power control module is positioned on the long edge seal. In a second embodiment, a battery pouch has a long edge seal and a short edge seal. An electrical connection tab and at least a portion of a power control module are positioned on the long edge seal.

### TECHNICAL FIELD

This disclosure relates generally to battery assemblies (or packs), and more specifically to placement and orientation of battery safety circuits and tabs in battery assemblies.

### BACKGROUND

Battery packs (or assemblies) often include one or more energy storage components that are placed within a battery pouch. Such battery packs typically are configured to have a longer horizontal dimension and a shorter horizontal dimension. The battery pouch often includes one or more pouch edges, such as one or more pouch edges along the longer horizontal dimension and one or more pouch edges along the shorter horizontal dimension. Typically, these pouch edges are sealed (such as by heat sealing) and may then be folded to reduce horizontal space occupied by the battery.

Battery packs may also include one or more electrical connection tabs (such as one or more positive electrodes and one or more negative electrodes) and/or one or more power control modules (also referred to as safety circuits). The electrical connection tabs may transfer energy or power from (such as for supplying energy or power to an electrical device into which the battery pack has been incorporated) and/or to the battery pack (such as to charge one or more energy storage components of the battery pack). The power control module may perform various operations that regulate the battery pack such as monitoring temperature of the battery pack to control overheating, regulating power transferred from and/or to the battery pack, and so on. In some cases, the power control module may be connected to the electrical connection tabs and/or to an electrical device into which the battery pack is incorporated via one or more flexible connectors (“flex connectors”).

### SUMMARY

The present disclosure discloses battery assemblies and methods for assembling batteries. In a first embodiment, a battery pouch may have at least one long edge seal and at least one short edge seal. At least one electrical connection tab may be positioned on the short edge seal and at least a portion of a power control module may be positioned on the long edge seal. As the power control module is positioned in a location other than the short edge seal, the short edge seal does not need to have sufficient dimensions to accommodate the power control module. As a result, the short edge seal may be constructed with smaller dimensions than would otherwise be possible, reducing the total dimension of the longer horizontal dimension of the battery assembly and/or increasing the amount of the longer horizontal area of the battery assembly that is available for energy storage components.

In a second embodiment, a battery pouch may have at least one long edge seal and at least one short edge seal and an electrical connection tab and at least a portion of a power control module may be positioned on the long edge seal. As the power control module and electrical connection tabs are positioned in a location other than the short edge seal, the short edge seal may be constructed with smaller dimensions than would otherwise be possible.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1A is an isometric view of a first embodiment of a battery assembly.

FIG. 1B is an isometric view of the battery assembly of FIG. 1A with a portion of the top surface of the battery pouch removed to illustrate internal components of the battery assembly.

FIG. 2 is a method diagram illustrating a first example method for assembling a battery. The battery may be the battery assembly of FIGS. 1A-1B.

FIG. 3A is an isometric view of a second embodiment of a battery assembly.

FIG. 3B is an isometric view of the battery assembly of FIG. 3A with a portion of the top surface of the battery pouch removed to illustrate internal components of the battery assembly.

FIG. 4 is a method diagram illustrating a second example method for assembling a battery. The battery may be the battery assembly of FIGS. 3A-3B.

### DETAILED DESCRIPTION

The description that follows includes sample systems, methods, and computer program products that embody various elements of the present disclosure. However, it should be understood that the described disclosure may be practiced in a variety of forms in addition to those described herein.

Often, electrical connection tabs and the power control modules are located on the shorter horizontal dimension pouch edge of a battery assembly (or pack). These elements require a certain amount of space and therefore require that the shorter horizontal dimension pouch edge of the battery assembly includes sufficient space to accommodate them. As a result, the shorter horizontal dimension pouch edge of the battery assembly may be required to have larger dimensions than would otherwise be required for purposes such as sealing the battery pack. Further, the dimensions required for the shorter horizontal dimension pouch edge of the battery assembly may increase the total dimension of the longer horizontal dimension of the battery assembly and/or reduce the amount of the longer horizontal area of the battery assembly that is available for energy storage components in order to meet battery assembly dimension limitations.

The present disclosure discloses battery assemblies and methods for assembling batteries. In a first embodiment, a battery pouch may have at least one long edge seal and at least one short edge seal. At least one electrical connection tab may be positioned on the short edge seal. Further, a power control module (or at least a portion of the power control module, such as a temperature sensor or other such component of the power control module) may be positioned on the long edge seal. As the power control module is positioned in a location other than the short edge seal, the short edge seal does not need to have sufficient dimensions to accommodate the power control module. As a result, the short edge seal may be constructed with smaller dimensions than would otherwise be possible, reducing the total dimension of the longer horizontal dimension of the battery assembly and/or increasing the amount of the longer horizontal area of the battery assembly that is available for energy storage components.

In a second embodiment, a battery pouch may have at least one long edge seal and at least one short edge seal. At least one electrical connection tab may be positioned on the long edge seal. Further, a power control module (or at least a portion of the power control module, such as a temperature sensor or other such component of the power control module) may also be positioned on the long edge seal. As the power control module and electrical connection tabs are positioned in a location other than the short edge seal, the short edge seal does not need to have sufficient dimensions to accommodate the power control module or the electrical connection tabs. As a result, the short edge seal may be constructed with smaller dimensions than would otherwise be possible, reducing the total dimension of the longer horizontal dimension of the battery assembly and/or increasing the amount of the longer horizontal area of the battery assembly that is available for energy storage components.

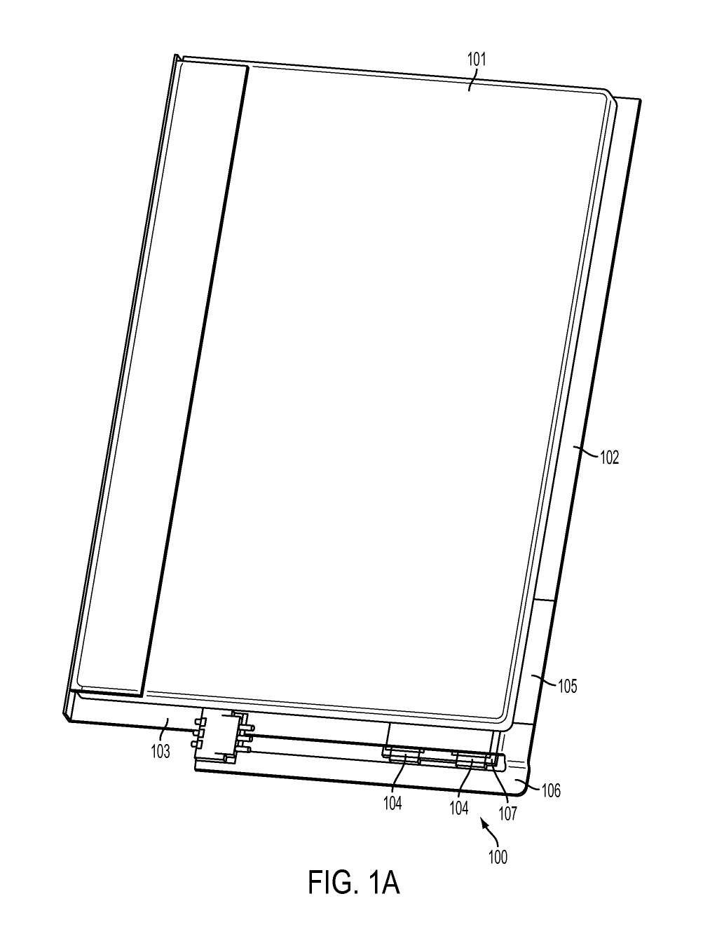

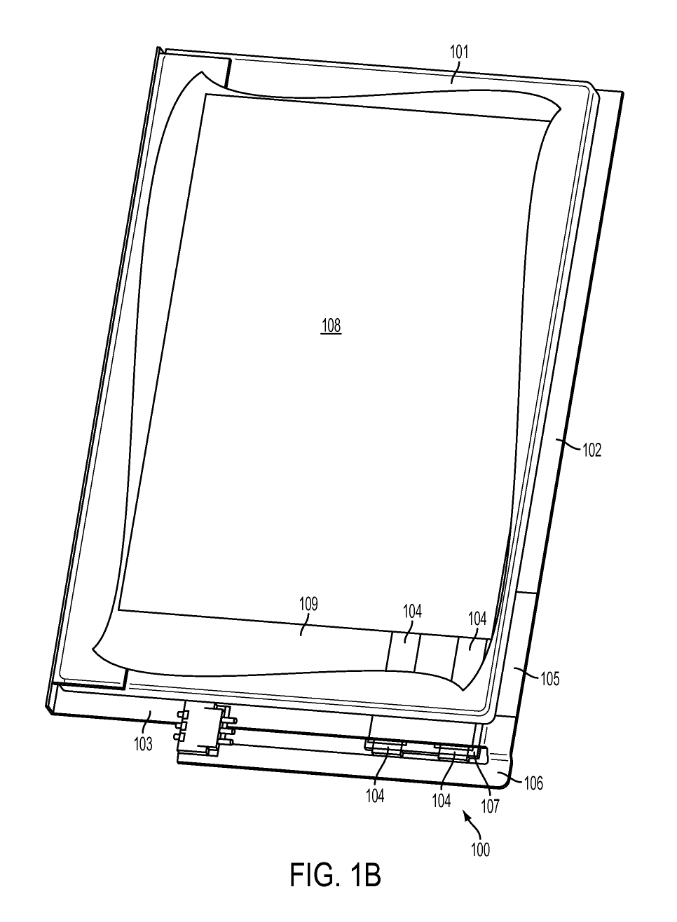

FIG. 1A is an isometric view of a first embodiment of a battery assembly (or pack) 100 in accordance with one or more examples of the present disclosure. The battery assembly may be utilized with a variety of different electrical devices, such as one or more mobile computing devices, laptop computers, personal digital assistants, tablet computers, digital music players, digital video players, cellular telephones, smart phones, wireless computer peripherals, battery powered kitchen appliances, and so on.

As illustrated, the battery assembly 100 includes a battery pouch 101. As is also illustrated, the battery pouch includes a edge seal 102 and a edge seal 103. A power control module 105 (or safety circuit) may be positioned on the edge seal 102. One or more electrical contact tabs 104 may be positioned on the edge seal 103.

As can be seen from FIG. 1A, the battery assembly 100 is longer than it is wide. As such, the battery assembly has a longer dimension (corresponding to the length of the battery assembly) and a shorter dimension (corresponding to the width of the battery). Thus, the edge seal 102 is a long edge seal (extending the distance of the longer dimension corresponding to the length of the battery assembly) and the edge seal 103 is a short edge seal (extending the distance of the shorter dimension corresponding to the width of the battery assembly). Therefore, the power control module 105 is shown as positioned on the long edge seal and the electrical contact tabs 104 are shown as positioned on the short edge seal.

In this illustration, the electrical contact tabs 104 are shown as a pair of electrodes (one being positive and one being negative). However, it is understood that this is for the purposes of example and is not intended to be limiting. Any number of electrical contact tabs may be utilized without departing from the scope of the present disclosure.

Further, the short edge seal 103 is illustrated in FIG. 1A as including a terrace 107. As shown, the terrace 107 supports the electrical contact tabs 104. However, it is understood that this is merely an example implementation. In other implementations, the short edge seal 103 may support the electrical contact tabs directly and may not include a terrace without departing from the scope of the present disclosure.

The power control module 105 may include one or more components (not shown) for regulating the battery assembly 100. Such regulation may include, but is not limited to, monitoring temperature of the battery assembly to control overheating, regulating power or energy transferred from and/or to the battery assembly, ensuring that power or energy is not discharged from the battery assembly too quickly, and/or other such battery assembly regulation functions.

The battery assembly 100 may also include one or more flexible connectors 106 (“flex connectors”). As illustrated in FIG. 1A, the flexible connector connects the electrical contacts 104 to the power control module 105. The flexible connector may also connect the power control module to one or more other components of the battery assembly and/or to one or more other components, such as an electrical device into which the battery assembly has been incorporated. In such cases, the power control module may function as a power or energy interface (and/or other kind of interface) between the battery assembly and an electrical device (i.e., delivering power from the battery assembly to the electrical device and/or from the electrical device to the battery assembly) into which the battery assembly has been incorporated.

FIG. 1A is illustrated and described above with the power control module 105 entirely positioned on the long edge seal 102. However, it is understood that this is an example implementation. In other implementations, only a portion of the power control module may be positioned on the long edge seal without departing from the scope of the present disclosure. In such implementations, one or more other portions of the power control module may be positioned on other locations of the battery assembly 100 and/or may even be located separate from the battery assembly. In cases where one or more other portions of the power control module are located separate from the battery assembly, the one or more other portions may be operably or communicably connected to the portion of the power control module positioned on the long edge seal via one or more flex connectors.

For example, positioning the power control module 105 separate from the battery assembly 100 may even further reduce horizontal dimensions of the battery assembly as space is not required for the power control module on either the long edge seal 102 or the short edge seal 103. However, one or more components of the power control module may not function correctly if not positioned directly on the battery assembly (or within sufficient proximity to specific locations of the battery assembly), such as one or more temperature detectors which may not be able to accurately determine battery assembly temperature if located remote from the battery assembly. In such cases, the one or more components that must be positioned on the battery assembly in order to function may be positioned on the battery assembly separate from the rest of the power control module and may be communicably connected (such as via one or more flex connectors and/or other connectors) to the other portions of the power control module.

Although FIG. 1A is illustrated and described above as connecting components utilizing flex connectors, it is understood that this is an example implementation. In other implementations, one or more connectors that are not flex connectors may be utilized to connect components without departing from the scope of the present disclosure.

In various implementations, the long edge seal 102 and/or the short edge seal 103 may be sealed (such as by heat sealing where heat is applied to one or more surfaces of the long edge seal and/or the short edge seal) and/or folded in order to reduce space occupied by the long edge seal and/or the short edge seal. However, in other implementations, the long edge seal and/or the short edge seal may not be sealed and/or may not be folded without departing from the scope of the present disclosure.

FIG. 1B illustrates the battery assembly 100 of FIG. 1A where a portion of the battery pouch 101 has been cut away to show internal components of the battery assembly. As illustrated, an energy storage component 108 has been placed within the battery pouch and is connected to the electrical connection tabs 104. As also illustrated, due to connection with the electrical connection tabs, the energy storage component only occupies a first portion of the battery pouch. A second portion 109 of the battery pouch may not be occupied by the energy storage component in order to provide space of the electrical connection tabs. In some cases, the second portion 109 may be empty space, though in other cases other components may be positioned in the second portion 109 in order to conserve space.

Regardless, as the energy storage component 108 may already be only able to occupy a portion of the battery pouch 101, space required by the short edge seal 103 may further reduce the possible size of the energy storage component in order for the battery assembly 100 to be able to meet horizontal battery assembly dimension limitations or battery “footprint” (i.e., maximum possible dimensions that the battery assembly must fit within). As positioning the power control module 105 on the long edge seal 102 may reduce the required dimensions of the short edge seal, more space within the battery pouch may be available for the energy storage component. Therefore, a larger energy storage component may be utilized than would otherwise be possible.

Although FIG. 1B is illustrated and described above as only including a single energy storage component 108 within the battery pouch 101, it is understood that this is an example implementation. In other implementations, multiple energy storage components may be placed within the battery pouch without departing from the scope of the present disclosure.

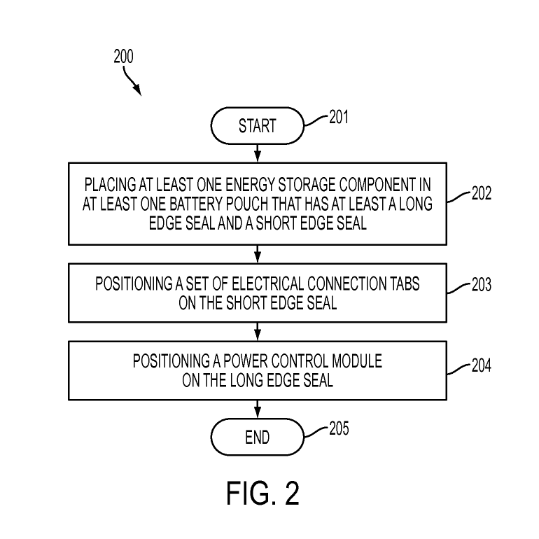

FIG. 2 illustrates a first example method 200 for assembling a battery. The resulting battery may be the battery assembly of FIGS. 1A-1B. The flow begins at block 201 and proceeds to block 202 where at least one energy storage component is placed in at least one battery storage pouch that has at least a long edge seal and a short edge seal. The flow then proceeds to block 203 where a set of electrical connection tabs is positioned on the short edge seal. Next, the flow proceeds to block 204 where a power control module is placed on the long edge seal. Finally, the flow proceeds to block 205 and ends.

Although the method 200 is illustrated and described above as including particular operations performed in a particular order, other arrangements (which may include other operations) are possible.

By way of a first example, the method 200 is illustrated and described above as placing an energy storage component in the battery pouch. However, in various implementations, the method may include an operation of providing a battery pouch instead of the operation of placing the energy storage component in the battery pouch without departing from the scope of the present disclosure.

By way of a second example, the method 200 is illustrated and described above as positioning a set of electrical connection tabs on the short edge seal. However, in various implementations, the method may position a single electrical connection tab or various combinations of multiple electrical connection tabs on the short edge seal without departing from the scope of the present disclosure.

By way of a third example, the method 200 is illustrated and described above as positioning an entire power control module on the long edge seal. However, in various implementations, the method may position only a portion of the power control module on the long edge seal without departing from the scope of the present disclosure. In such cases, one or more other portions of the power control module may be positioned on other portions of the battery and/or separate from the battery and may be operably coupled to the portion of the power control module positioned on the long edge seal.

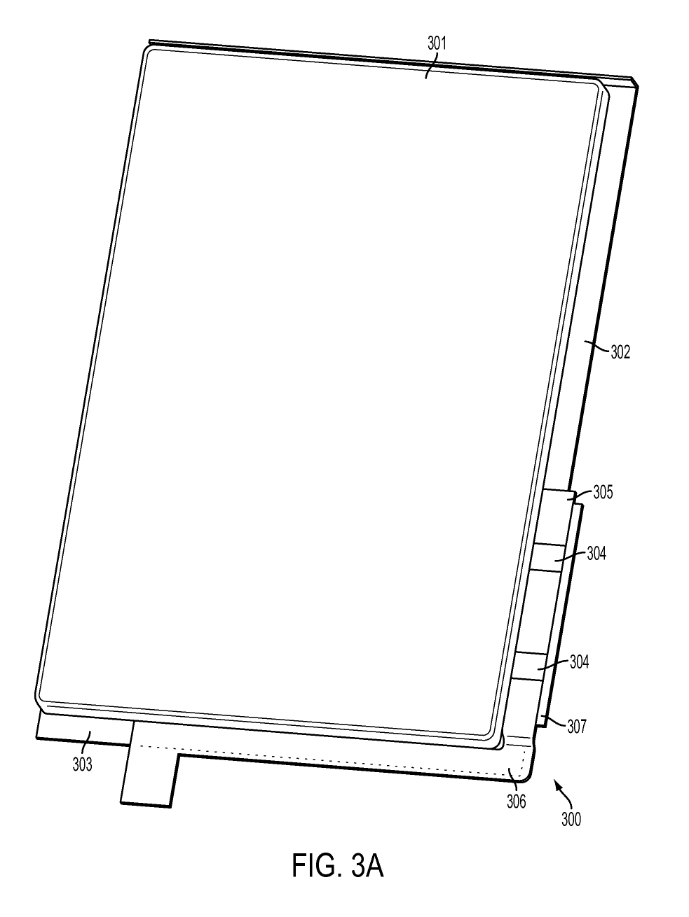

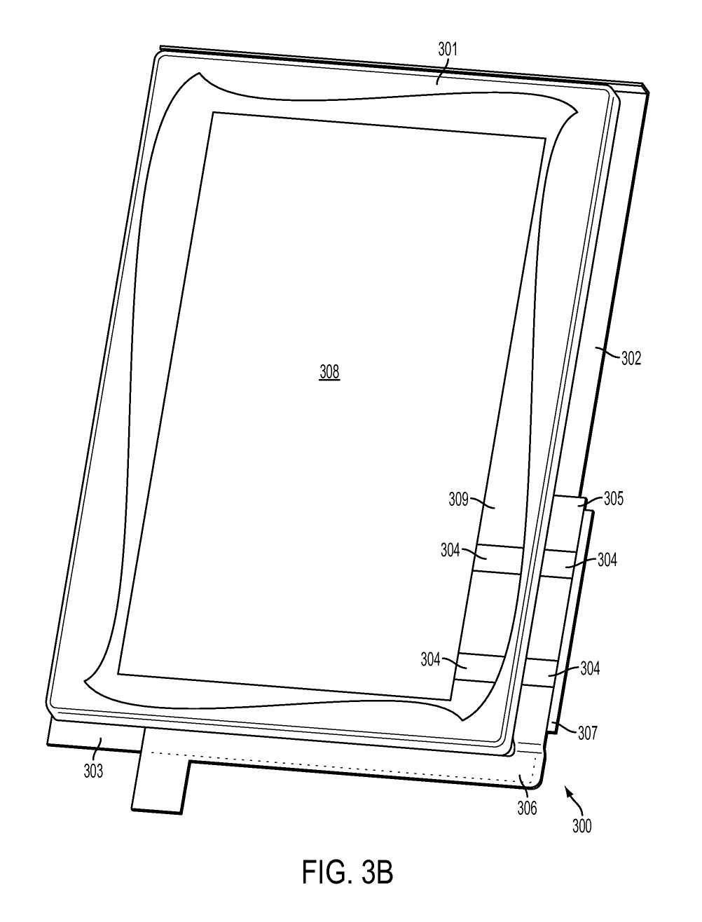

FIG. 3A is an isometric view of a second embodiment of a battery assembly (or pack) 300 in accordance with one or more examples of the present disclosure. The battery assembly may be utilized with a variety of different electrical devices, such as one or more mobile computing devices, laptop computers, personal digital assistants, tablet computers, digital music players, digital video players, cellular telephones, smart phones, wireless computer peripherals, battery powered kitchen appliances, and so on. As illustrated, the battery assembly 300 includes a battery pouch 301. As is also illustrated, the battery pouch includes a edge seal 302 and a edge seal 303. A power control module 305 (or safety circuit) and/or one or more electrical contact tabs 304 may be positioned on the edge seal 302. As can be seen from FIG. 3A, the battery assembly 300 is longer than it is wide. As such, the battery assembly has a longer dimension (corresponding to the length of the battery assembly) and a shorter dimension (corresponding to the width of the battery). Thus, the edge seal 302 is a long edge seal (extending the distance of the longer dimension corresponding to the length of the battery assembly) and the edge seal 303 is a short edge seal (extending the distance of the shorter dimension corresponding to the width of the battery assembly). Therefore, the power control module 305 and the electrical contact tabs 104 are shown as positioned on the long edge seal.

In this illustration, the electrical contact tabs 304 are shown as a pair of electrodes (one being positive and one being negative). However, it is understood that this is for the purposes of example and is not intended to be limiting. Any number of electrical contact tabs may be utilized without departing from the scope of the present disclosure. Further, the long edge seal 302 is illustrated in FIG. 3A as including a terrace 307. As shown, the terrace 307 supports the electrical contact tabs 104 and /or the power control module 305. However, it is understood that this is merely an example implementation. In other implementations, the long edge seal may support the electrical contact tabs and/or the power control module directly and may not include a terrace without departing from the scope of the present disclosure.

The power control module 305 may include one or more components (not shown) for regulating the battery assembly 300. Such regulation may include, but is not limited to, monitoring temperature of the battery assembly to control overheating, regulating power or energy transferred from and/or to the battery assembly, ensuring that power or energy is not discharged from the battery assembly too quickly, and/or other such battery assembly regulation functions. FIG. 3A is illustrated and described above with the power control module 305 entirely positioned on the long edge seal 302. However, it is understood that this is an example implementation. In other implementations, only a portion of the power control module may be positioned on the long edge seal without departing from the scope of the present disclosure. In such implementations, one or more other portions of the power control module may be positioned on other locations of the battery assembly 300 and/or may even be located separate from the battery assembly. In cases where one or more other portions of the power control module are located separate from the battery assembly, the one or more other portions may be operably or communicably connected to the portion of the power control module positioned on the long edge seal via one or more flex connectors.

For example, positioning the power control module 305 separate from the battery assembly 300 may even further reduce horizontal dimensions of the battery assembly as space is not required for the power control module on either the long edge seal 302 or the short edge seal 303. However, one or more components of the power control module may not function correctly if not positioned directly on the battery assembly (or within sufficient proximity to specific locations of the battery assembly), such as one or more temperature detectors which may not be able to accurately determine battery assembly temperature if located remote from the battery assembly. In such cases, the one or more components that must be positioned on the battery assembly in order to function may be positioned on the battery assembly separate from the rest of the power control module and may be communicably connected (such as via one or more flex connectors and/or other connectors) to the other portions of the power control module.

FIG. 3A is illustrated and described above with the electrical connection tabs 304 and the power control module 305 being co-located on the long edge seal 302. Such co-location may be performed in order to reduce the portion of the long edge seal occupied by the electrical connection tabs and/or the power control module. However, it is understood that this is an example implementation and other arrangements are possible without departing from the scope of the present disclosure. In other implementations, the electrical connection tabs and the power control module (or at least one or more portions of the power control module) may be positioned on different portions of the long edge seal. Such different placement may be performed based on concerns regarding prevention of interference between the electrical connection tabs and the power control module.

The battery assembly 300 may also include one or more flexible connectors 306 (“flex connectors”). As illustrated in FIG. 3A, the flexible connector connects the electrical contacts 304 and the power control module 305. The flexible connector may also connect the power control module to one or more other components of the battery assembly and/or to one or more other components, such as an electrical device into which the battery assembly has been incorporated. In such cases, the power control module may function as a power or energy interface (and/or other kind of interface) between the battery assembly and an electrical device (i.e., delivering power from the battery assembly to the electrical device and/or from the electrical device to the battery assembly) into which the battery assembly has been incorporated. Although FIG. 3A is illustrated and described above as connecting components utilizing flex connectors, it is understood that this is an example implementation. In other implementations, one or more connectors that are not flex connectors may be utilized to connect components without departing from the scope of the present disclosure.

In various implementations, the long edge seal 302 and/or the short edge seal 303 may be sealed (such as by heat sealing where heat is applied to one or more surfaces of the long edge seal and/or the short edge seal and/or folded in order to reduce space occupied by the long edge seal and/or the short edge seal. However, in other implementations, the long edge seal and/or the short edge seal may not be sealed and/or may not be folded without departing from the scope of the present disclosure.

FIG. 3B illustrates the battery assembly 300 of FIG. 3A where a portion of the battery pouch 301 has been cut away to show internal components of the battery assembly. As illustrated, an energy storage component 308 has been placed within the battery pouch and is connected to the electrical connection tabs 304. As also illustrated, due to connection with the electrical connection tabs, the energy storage component only occupies a first portion of the battery pouch. A second portion 309 of the battery pouch may not be occupied by the energy storage component in order to provide space of the electrical connection tabs. In some cases, the second portion 309 may be empty space, though in other cases other components may be positioned in the second portion 309 in order to conserve space. Regardless, as the energy storage component 308 may already be only able to occupy a portion of the battery pouch 301, space required by the short edge seal 303 may further reduce the possible size of the energy storage component in order for the battery assembly 300 to be able to meet horizontal battery assembly dimension limitations or battery “footprint” (i.e., maximum possible dimensions that the battery assembly must fit within). As positioning the power control module 305 and/or the electrical connection tabs 304 on the long edge seal 302 may reduce the required dimensions of the short edge seal, more space within the battery pouch may be available for the energy storage component. Therefore, a larger energy storage component may be utilized than would otherwise be possible.

Although FIG. 3B is illustrated and described above as only including a single energy storage component 308 within the battery pouch 301, it is understood that this is an example implementation. In other implementations, multiple energy storage components may be placed within the battery pouch without departing from the scope of the present disclosure.

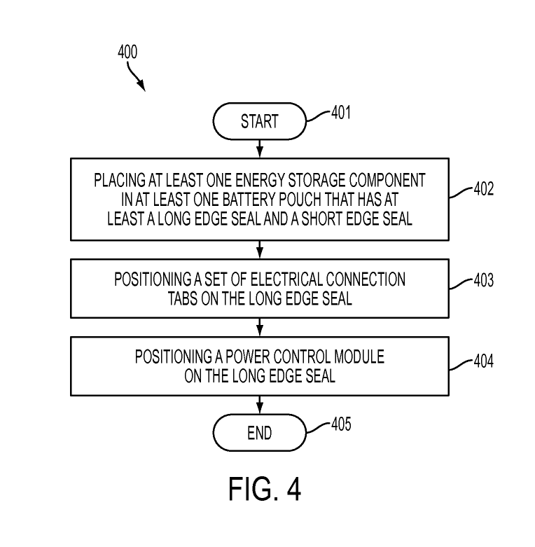

FIG. 4 illustrates a second example method 400 for assembling a battery. The resulting battery may be the battery assembly of FIGS. 3A-3B. The flow begins at block 401 and proceeds to block 402 where at least one energy storage component is placed in at least one battery storage pouch that has at least a long edge seal and a short edge seal. The flow then proceeds to block 403 where a set of electrical connection tabs is positioned on the long edge seal. Next, the flow proceeds to block 404 where a power control module is placed on the long edge seal. Finally, the flow proceeds to block 405 and ends.

In some implementations, the electrical connection tabs and the power control module may be co-located on the long edge seal. Such co-location may be performed in order to reduce the portion of the long edge seal occupied by the electrical connection tabs and/or the power control module. However, in other implementation, the electrical connection tabs and the power control module may be positioned on different portions of the long edge seal. Such different placement may be performed based on concerns regarding prevention of interference between the electrical connection tabs and the power control module.

Although the method 400 is illustrated and described above as including particular operations performed in a particular order, other arrangements (which may include other operations) are possible. By way of a first example, the method 400 is illustrated and described above as placing an energy storage component in the battery pouch. However, in various implementations, the method may include an operation of providing a battery pouch instead of the operation of placing the energy storage component in the battery pouch without departing from the scope of the present disclosure.

By way of a second example, the method 400 is illustrated and described above as positioning a set of electrical connection tabs on the long edge seal. However, in various implementations, the method may position a single electrical connection tab or various combinations of multiple electrical connection tabs on the long edge seal without departing from the scope of the present disclosure.

By way of a third example, the method 400 is illustrated and described above as positioning an entire power control module on the long edge seal. However, in various implementations, the method may position only a portion of the power control module on the long edge seal without departing from the scope of the present disclosure. In such cases, one or more other portions of the power control module may be positioned on other portions of the battery and/or separate from the battery and may be operably coupled to the portion of the power control module positioned on the long edge seal.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A method for assembling a battery, the method comprising:
providing at least one battery pouch that has at least a long edge seal and a short edge seal;
positioning at least one electrical connection tab on the short edge seal of the at least one battery pouch; and
positioning at least a portion of a power control module on the long edge seal of the at least one battery pouch.

2. The method of claim 1, wherein at least one additional portion of the power control module is located separate from the battery and is operably connected to the at least a portion of the power control module.

3. The method of claim 2, wherein the at least a portion of the power control module comprises at least a temperature detector component.

4. The method of claim 1, further comprising:
sealing at least one of the short edge seal of the at least one battery pouch or the long edge seal of the at least one battery pouch, or
folding at least one of the short edge seal of the at least one battery pouch or the long edge seal of the at least one battery pouch.

5. The method of claim 1, further comprising:
connecting at least one flexible connector to the at least a portion of the power control module.

6. The method of claim 5, wherein the at least one flexible connector connects the at least a portion of the power control module to the at least one electrical connection tab.

7. The method of claim 6, wherein the at least a portion of the power control module is operable to deliver power to at least one electrical device from at least one energy storage component located within the at least one battery pouch via the at least one flexible connector.

8. The method of claim 1, further comprising:
placing at least one energy storage component in the at least one battery pouch.

9. The method of claim 1, wherein the at least one electrical connection tab comprises at least one positive electrode and at least one negative electrode.

10. A battery assembly, comprising:
at least one battery pouch that has at least a long edge seal and a short edge seal;
at least one electrical connection tab positioned on the short edge seal of the at least one battery pouch; and
at least a portion of a power control module positioned on the long edge seal of the at least one battery pouch.

11. A method for assembling a battery, the method comprising:
providing at least one battery pouch that has at least a long edge seal and a short edge seal;
positioning at least one electrical connection tab on the long edge seal of the at least one battery pouch; and
positioning at least a portion of a power control module on the long edge seal of the at least one battery pouch.

12. The method of claim 11, further comprising:
connecting at least one flexible connector to the at least a portion of the power control module.

13. The method of claim 12, wherein the at least one flexible connector connects the at least a portion of the power control module to the at least one electrical connection tab.

14. The method of claim 13, wherein the at least a portion of the power control module is operable to deliver power to at least one electrical device from at least one energy storage component located within the at least one battery pouch via the at least one flexible connector.

15. The method of claim 11, wherein at least one additional portion of the power control module is located separate from the battery and is operably connected to the at least a portion of the power control module.

16. The method of claim 15, wherein the at least a portion of the power control module comprises at least a temperature detector component.

17. The method of claim 11, further comprising:
placing at least one energy storage component in the at least one battery pouch.

18. The method of claim 11, wherein the at least one electrical connection tab comprises at least one positive electrode and at least one negative electrode.

19. The method of claim 11, further comprising:
sealing at least one of the short edge seal of the at least one battery pouch or the long edge seal of the at least one battery pouch, or
folding at least one of the short edge seal of the at least one battery pouch or the long edge seal of the at least one battery pouch.

20. A battery assembly, comprising:
at least one battery pouch that has at least a long edge seal and a short edge seal;
at least one electrical connection tab positioned on the long edge seal of the at least one battery pouch; and
at least a portion of a power control module positioned on the long edge seal of the at least one battery pouch.
